(19) United States
(12) Patent Application Publication
(10) Pub. No.: US 2026/0279198 A1
(43) Pub. Date: Sep. 17, 2026

(54) SYSTEM AND METHOD FOR EMERGENCY SUPERVISION OF TUNNEL TRAFFIC IN SMART CITIES BASED ON INTERNET OF THINGS LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/681,174

(22) Filed: May 19, 2026

(30) Foreign Application Priority Data
Apr. 21, 2026 (CN) 202610526704.5

(51) Int. Cl. G08G 1/08; G08G 1/01

(52) U.S. Cl. CPC G08G 1/08; G08G 1/0108; G08G 1/0133; G08G 1/0145

(57) ABSTRACT

Provided is a system and a method for emergency supervision of tunnel traffic in smart cities based on an Internet of Things (IoT) large model. The method comprises: constructing a fusion feature vector of a vehicle in a target tunnel based on multi-dimensional data of the target tunnel; determining an abnormal event based on the fusion feature vector and congestion data of the target tunnel; predicting an upstream congestion condition of the target tunnel based on the abnormal event, the congestion data, and peripheral traffic flow data of the target tunnel; and generating a signal regulation instruction including a passage duration according to the upstream congestion condition, the signal regulation instruction being configured to control a target signal light to maintain a target state for the passage duration, and the target signal light being a signal light on a key road section in a direction toward the target tunnel.

### CROSS REFERENCE TO RELATED APPLICATIONS

The present disclosure claims priority to Chinese patent application No. 202610526704.5, filed on Apr. 21, 2026, the entire contents of which are incorporated herein by reference.

### TECHNICAL FIELD

The present disclosure generally relates to a field of traffic supervision, and in particular to a system for emergency supervision of tunnel traffic in smart cities based on an Internet of Things (IoT) large model, a method for emergency supervision of tunnel traffic in smart cities, and a non-transitory computer-readable storage medium.

### BACKGROUND

With the gradual increase in urban population, urban tunnel traffic is also becoming increasingly developed. The supervision of urban traffic has become an indispensable part of improving residents' quality of life.

In current traffic supervision systems, perception methods for traffic events are single, responses are passive, and regulation measures are limited to local road sections, making it difficult to proactively prevent and fundamentally alleviate congestion.

To address the above problems, there is an urgent need to provide a system for emergency supervision of tunnel traffic in smart cities based on an Internet of Things (IoT) large model and a method for emergency supervision of tunnel traffic in smart cities, which can predict surrounding congestion conditions by linking with a regional road network and perform coordinated regulation of traffic conditions.

### SUMMARY

One or more embodiments of the present disclosure provide a system for emergency supervision of tunnel traffic in smart cities based on an Internet of Things (IoT) large model. The system includes an emergency supervision management platform. The emergency supervision management platform is configured to execute a method for emergency supervision of tunnel traffic in smart cities.

One or more embodiments of the present disclosure provide a method for emergency supervision of tunnel traffic in smart cities. The method is executed by an emergency supervision management platform. The method includes: constructing a fusion feature vector of a vehicle in a target tunnel according to multi-dimensional data of the target tunnel; determining an abnormal event according to the fusion feature vector and congestion data of the target tunnel; predicting an upstream congestion condition of the target tunnel according to the abnormal event, the congestion data, and peripheral traffic flow data of the target tunnel; generating a signal regulation instruction including a passage duration according to the upstream congestion condition; controlling a target signal light to maintain a target state for the passage duration according to the signal regulation instruction, wherein the target signal light is a signal light on a key road section in a direction toward the target tunnel.

One or more embodiments of the present disclosure provide a non-transitory computer-readable storage medium. The storage medium stores computer instructions. When a computer reads the computer instructions in the storage medium, the computer executes the method for emergency supervision of tunnel traffic in smart cities.

### BRIEF DESCRIPTION OF THE DRAWINGS

The present disclosure is further described in an illustrative manner by way of exemplary embodiments. These exemplary embodiments are described in detail with reference to the accompanying drawings. These embodiments are not limiting. In these embodiments, the same reference numerals denote the same structures, wherein:

FIG. 1 is a schematic diagram illustrating an exemplary structure of a system for emergency supervision of tunnel traffic in smart cities based on an Internet of Things (IoT) large model according to some embodiments of the present disclosure.

FIG. 2 is a flowchart illustrating an exemplary process of a method for emergency supervision of tunnel traffic in smart cities according to some embodiments of the present disclosure.

FIG. 3 is a schematic diagram illustrating an exemplary process for determining a passage duration according to some embodiments of the present disclosure.

FIG. 4 is a schematic diagram illustrating an exemplary abnormality identification model according to some embodiments of the present disclosure.

FIG. 5 is a schematic diagram illustrating an exemplary process for determining an upstream congestion condition according to some embodiments of the present disclosure.

### DETAILED DESCRIPTION

To more clearly illustrate the technical solutions of the embodiments of the present disclosure, the accompanying drawings to be used in the description of the embodiments will be briefly introduced below. Evidently, the accompanying drawings in the following description are merely some examples or embodiments of the present disclosure. For a person of ordinary skill in the art, without making inventive efforts, the present disclosure may also be applied to other similar scenarios according to these accompanying drawings. Unless obviously indicated from the context or otherwise specified, same reference numerals in the figures represent the same structures or operations.

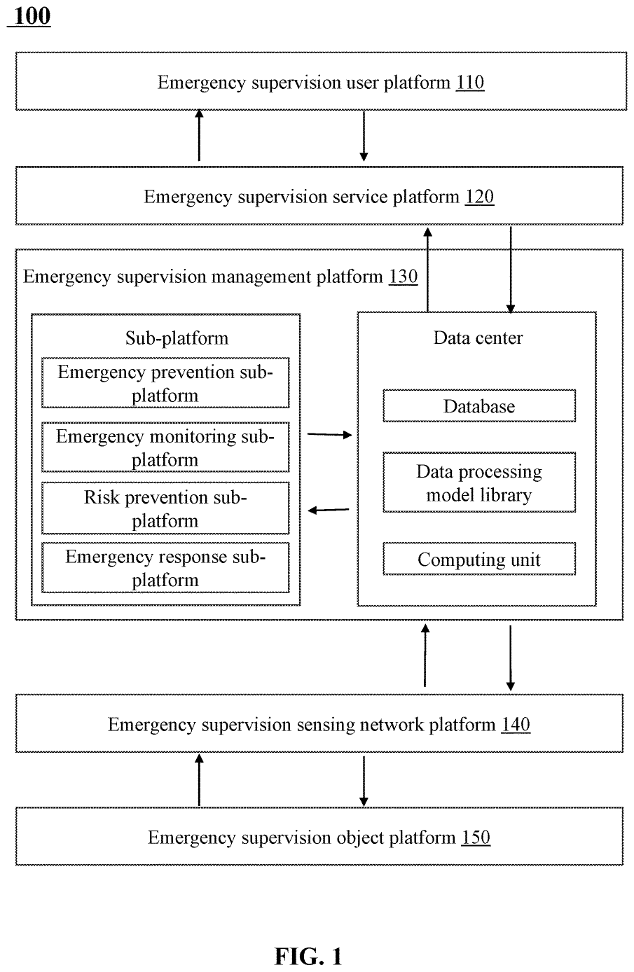

FIG. 1 is a schematic diagram illustrating an exemplary structure of a system for emergency supervision of tunnel traffic in smart cities based on an Internet of Things (IoT) large model according to some embodiments of the present disclosure.

In some embodiments, as shown in FIG. 1, the system for emergency supervision of tunnel traffic in smart cities based on an Internet of IoT large model (hereinafter referred to as the system) 100 may include an emergency supervision management platform 130.

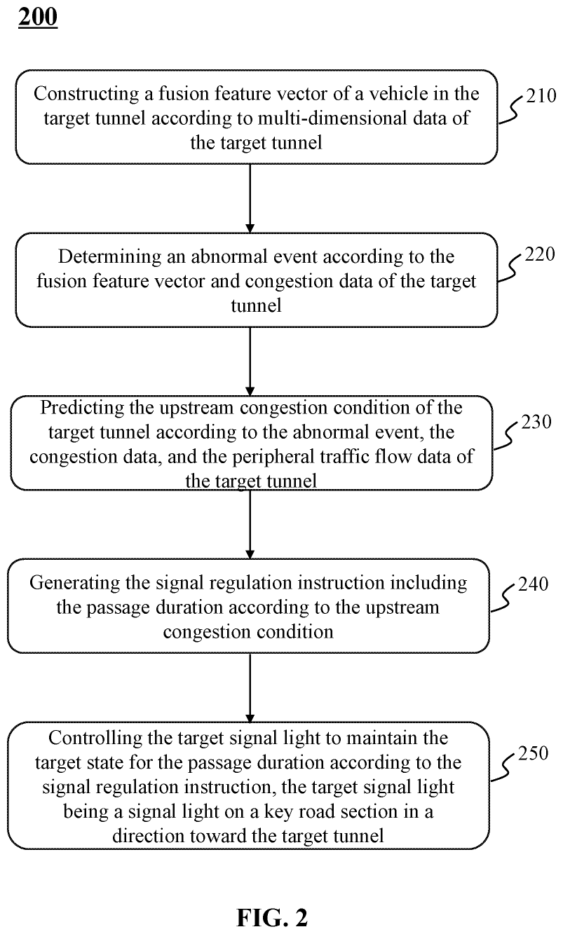

The emergency supervision management platform 130 refers to a digital monitoring and management platform for supervising traffic emergency events. The traffic emergency event refers to a sudden traffic event that is destructive and harmful. For example, an abnormal event. For a description of the abnormal event, refer to FIG. 2 and the content thereof.

In some embodiments, the emergency supervision management platform 130 may be configured in a processor and/or a server. The processor and/or the server may process data and/or information obtained from other platforms. The processor and/or the server may execute program instructions based on the data, the information, and/or the processing results, to execute one or more functions described in the present disclosure.

In some embodiments, the emergency supervision management platform 130 includes a sub-platform and a data center that are in mutual communication. The sub-platform may process data and/or information obtained from the data center.

In some embodiments, the sub-platform includes at least one of an emergency prevention sub-platform, an emergency monitoring sub-platform, a risk prevention sub-platform, and an emergency response sub-platform.

The emergency prevention sub-platform refers to a management platform for evaluating and preventing the traffic emergency events.

The emergency monitoring sub-platform refers to a platform for monitoring, collecting, and analyzing data of the traffic emergency events.

The risk prevention sub-platform refers to a platform for identifying potential risks, evaluating risk levels, and implementing risk mitigation strategies.

The emergency response sub-platform refers to a platform for coordinating, scheduling, and executing emergency plans after the occurrence of the traffic emergency events.

In some embodiments, the data center includes a database, a data processing model library, and a computing unit.

The database is used for collecting, storing, and managing a large amount of data related to emergency management. For example, MySQL, PostgreSQL, InfluxDB, and Prometheus.

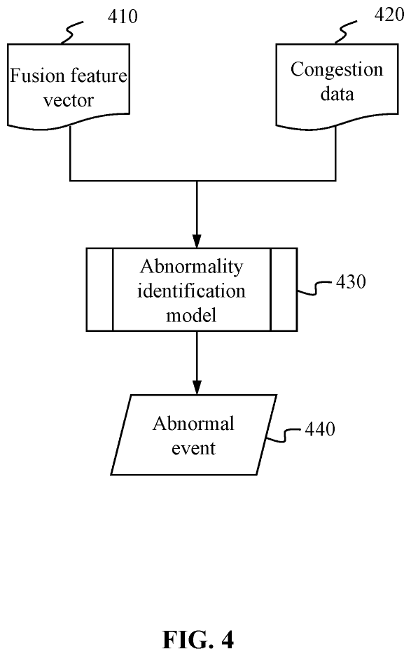

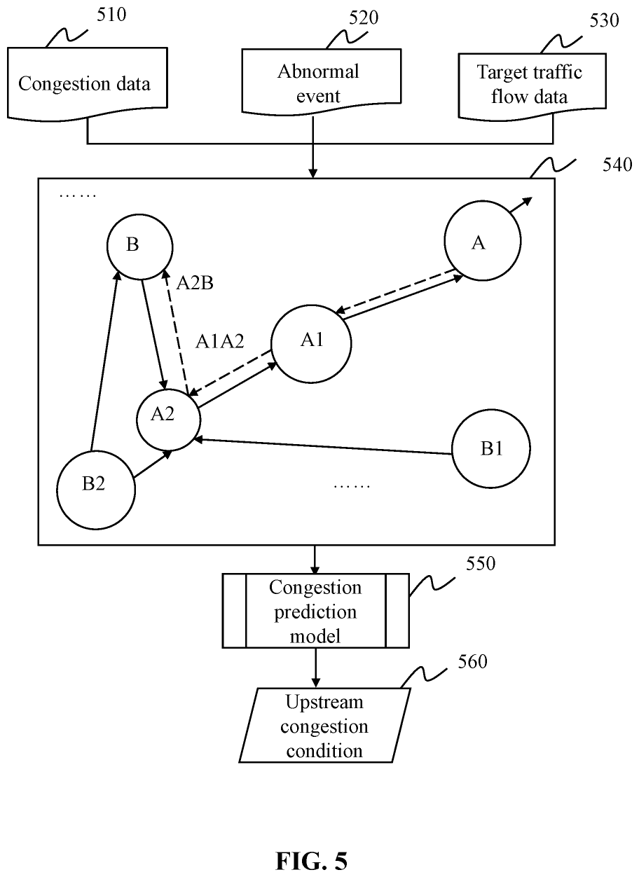

The data processing model library refers to a collection of data processing models for processing emergency management data. In some embodiments, the data processing models may include an abnormality identification model, a congestion prediction model, and the like. For a description of the abnormality identification model, refer to FIG. 4 and the content thereof. For a description of the congestion prediction model, refer to FIG. 5 and the content thereof.

The computing unit refers to a functional module for executing arithmetic, logic, and other instruction operations. The computing unit may include, but is not limited to, a central processing unit (CPU), and the like.

In some embodiments, the system 100 further includes an emergency supervision user platform 110, an emergency supervision service platform 120, an emergency supervision sensing network platform 140, and an emergency supervision object platform 150.

The emergency supervision user platform refers to an interactive platform for emergency management personnel and the public. In some embodiments, the emergency supervision user platform may include at least one personnel interaction device. For example, mobile phones, computers, and the like.

The emergency supervision service platform refers to a platform for providing emergency supervision services. In some embodiments, the emergency supervision service platform may be configured as a server, and may perform data interaction with the emergency supervision user platform and the emergency supervision management platform (e.g., the data center). For example, after detecting a traffic emergency event, the public uses the emergency supervision user platform to report the event condition to the emergency supervision service platform, the emergency supervision service platform reports relevant events and their impact assessment to the emergency supervision management platform, so as to facilitate the management department to respond and make decisions.

The emergency supervision sensing network platform refers to a platform for sensing communication of emergency supervision information in smart cities, which is used for communication transmission to achieve two-way data interaction between the emergency supervision management platform (e.g., the data center) and the emergency supervision object platform. For example, the emergency supervision sensing network platform may include communication equipment, a server, various gateway devices, and the like. The emergency supervision information in smart cities may include multi-dimensional data of a target tunnel, an abnormal event, an upstream congestion condition, and the like. For a description of multi-dimensional data of a target tunnel and an upstream congestion condition, refer to FIG. 2 and the content thereof.

The emergency supervision object platform refers to an information processing platform for safely supervising various supervision objects involved in emergency management. The supervision objects may include non-motorized vehicle lanes, transportation hubs, public activity places, and the like. The emergency supervision object platform may include a plurality of monitoring, sensing, and interaction devices, for example, cameras, fire alarms, hazardous gas leak detectors, environmental monitoring sensors, and the like.

In some embodiments of the present disclosure, an information operation closed loop can be formed among the functional platforms through the system 100, and the system 100 can operate coordinately and regularly under the unified management of the emergency supervision management platform, so as to achieve the informatization and intellectualization of traffic emergency supervision.

FIG. 2 is a flowchart illustrating an exemplary process of a method for emergency supervision of tunnel traffic in smart cities according to some embodiments of the present disclosure.

As shown in FIG. 2, the process 200 includes the following steps. In some embodiments, the process 200 may be executed by the emergency supervision management platform.

Step 210, constructing a fusion feature vector of a vehicle in the target tunnel according to multi-dimensional data of the target tunnel.

The target tunnel refers to a traffic tunnel that is monitored and managed by the system. For example, a main line tunnel of an urban expressway, a highway tunnel, and the like.

The multi-dimensional data refers to a collection of data comprehensively describing a traffic state of a road section from a plurality of dimensions.

In some embodiments, the multi-dimensional data may include timestamp, vehicle motion data, and vehicle identity information.

In some embodiments, the vehicle motion data includes vehicle position, instantaneous speed, and acceleration of a single vehicle, and the like.

The vehicle is a traffic tool that is driving or parked on a certain road section.

The vehicle position may be characterized based on three-dimensional coordinates of the vehicle.

In some embodiments, the vehicle identity information includes vehicle type, license plate number, lane, and the like.

The vehicle type is a type to which the vehicle belongs. For example, two-wheeled vehicles, passenger vehicles, freight vehicles, and the like.

In some embodiments, the multi-dimensional data may be obtained through various radars, sensors, and cameras.

In some embodiments, the vehicle motion data may be collected by a millimeter-wave radar.

In some embodiments, the vehicle identity information may be identified by the camera.

For example, when the vehicle enters a field of view of the camera, the radar captures the vehicle position, the instantaneous speed, and the acceleration, the camera identifies the license plate number, the vehicle type, the lane of the vehicle, and records the current timestamp.

The fusion feature vector is a time-series feature vector formed by integrating the multi-dimensional data. For example, the fusion feature vector of vehicle n is expressed by Fn=[timestamp, license plate number, vehicle type, vehicle position, instantaneous speed, acceleration, lane].

In some embodiments, the emergency supervision management platform may construct a fusion feature vector of a vehicle in the target tunnel according to the multi-dimensional data of the target tunnel.

In some embodiments, constructing the fusion feature vector by the emergency supervision management platform may include following steps:

S1, at least one radar and at least one camera operating based on the same clock are preset in the target tunnel, and the at least one camera is set at a key position of the target tunnel; the emergency supervision management platform records monitoring space information of each camera in advance; the at least one radar continuously collects anonymous motion data of all motion targets and uploads the anonymous motion data to the emergency supervision management platform in real time; the at least one camera continuously identifies vehicle identity information of all passing vehicles, records a corresponding timestamp, and uploads the vehicle identity information and the timestamp to the emergency supervision management platform in real time.

The key position is a preset installation point of the camera. For example, cameras may be installed at a fixed interval.

The monitoring space information refers to data of a three-dimensional physical space that the camera can monitor.

The anonymous motion data refers to vehicle motion data that does not involve identity information of the vehicle. The anonymous motion data includes timestamp, and a temporary Identifier (ID), vehicle position, instantaneous speed, and acceleration of the vehicle at the timestamp.

The motion targets refer to all moving entities in the target tunnel.

S2, after receiving identity information and a timestamp of a certain vehicle uploaded by the camera, the emergency supervision management platform queries the anonymous motion data based on the timestamp, determines a unique vehicle in the same monitoring space at the same moment in combination with the pre-recorded monitoring space information, and uniquely associates the anonymous motion data of the vehicle with the vehicle identity information.

S3, the emergency supervision management platform constructs a first fusion feature vector of the vehicle based on an association between the anonymous motion data of the vehicle and the vehicle identity information; and updates all anonymous motion data related to the vehicle uploaded by the radar to the fusion feature vector, so as to form a fusion feature vector sequence.

The fusion feature vector sequence refers to an ordered collection composed of a plurality of time-series fusion feature vectors during a process in which the same vehicle passes through the target tunnel.

Step 220, determining an abnormal event according to the fusion feature vector and congestion data of the target tunnel.

The congestion data refers to a data set characterizing a degree of traffic congestion of a road section.

In some embodiments, the congestion data may include lane flow, lane occupancy, vehicle queue length, average vehicle speed, and traffic density.

The lane flow refers to the number of vehicles passing through a road section per unit time.

The lane occupancy refers to a time ratio that a lane cross-section of a road section is occupied by vehicles within a preset time period.

In some embodiments, the lane flow and the lane occupancy may be acquired by sensors arranged on the lane cross-section.

The vehicle queue length refers to a length of a queue formed by vehicles in a road section.

In some embodiments, the vehicle queue length may be acquired based on a plurality of sensors continuously arranged on a lane. For example, for a lane from a start point to an end point, at least one sensor is arranged at a fixed distance. Each sensor has only two states, 0 and 1, where 0 indicates that the lane is not occupied, and 1 indicates that the lane is occupied. The emergency supervision management platform continuously obtains the state of each sensor. Starting from the first sensor whose state is 1 closest to the start point, the emergency supervision management platform identifies the number of consecutive sensors whose state is 1 along a direction toward the end point. The emergency supervision management platform multiplies the number of sensors by the fixed distance to determine the queue length.

The average vehicle speed refers to the average value of instantaneous speeds of all vehicles in a road section.

In some embodiments, the emergency supervision management platform may obtain the total number of vehicles and the instantaneous speed of each vehicle based on the fusion feature vector of each vehicle, and determine a ratio of a sum of the instantaneous speeds of the vehicles to the total number of vehicles as the average vehicle speed.

The traffic density refers to a ratio of a number of vehicles to an area of a region in a road section.

In some embodiments, the emergency supervision management platform may obtain the vehicle position of each vehicle based on the fusion feature vector of each vehicle, count the number of vehicles whose vehicle positions coincide with the position of the target tunnel, and determine a ratio of the number of vehicles to the area of the region as the traffic density of the target tunnel.

The abnormal event refers to an event occurring in a road section that deviates from a normal traffic operation state.

In some embodiments, the abnormal event may include an abnormality type, an abnormality degree, an abnormal vehicle, and an abnormal position point.

The abnormality type refers to a category to which the abnormal event belongs. For example, abnormal parking, illegal lane change, speeding, wrong-way driving, etc.

The abnormality degree refers to a quantitative indicator characterizing the severity of the abnormal event. For example, the abnormality degree is represented by a number from 0 to 100, where a larger value indicates a more severe abnormality degree.

The abnormal vehicle refers to a license plate number of the vehicle involved in the abnormal event.

The abnormal position point refers to position information of the abnormal event that occurs to the abnormal vehicle, which may be characterized based on three-dimensional coordinates and the corresponding lane, etc.

In some embodiments, the emergency supervision management platform may determine the abnormal event in a plurality of manners according to the fusion feature vector and the congestion data of the target tunnel.

In some embodiments, the emergency supervision management platform may construct a first target vector based on the fusion feature vector and the congestion data of a vehicle in the target tunnel. The emergency supervision management platform also constructs a first vector database based on a large amount of historical data from a data center. The first vector database includes a plurality of first reference vectors, a reference abnormality type corresponding to the first reference vector, and a reference abnormality degree corresponding to the first reference vector. Through vector matching, the emergency supervision management platform determines the first reference vector with the highest similarity to the first target vector and the corresponding highest similarity. There are two cases as follows: the highest similarity is greater than a similarity threshold, or the highest similarity is less than or equal to the similarity threshold. If the highest similarity is greater than the similarity threshold, the reference abnormality type and the reference abnormality degree corresponding to the first reference vector are determined as the abnormality type and the abnormality degree of the first target vector. The determined abnormality type and abnormality degree, together with the license plate number and the vehicle position in the fusion feature vector of the vehicle, constitute the abnormal event. If the highest similarity is less than or equal to the similarity threshold, it is determined that the vehicle has no abnormal event.

In some embodiments, the first reference vector may be constructed by obtaining the fusion feature vector and the congestion data of an abnormal vehicle when an abnormal event actually occurs in the historical data. By manually annotating the abnormality type and the abnormality degree of the abnormal event, the reference abnormality type and the reference abnormality degree are obtained.

The similarity threshold may be preset based on historical experience.

In some embodiments, the emergency supervision management platform may also determine the abnormal event through an abnormality identification model. For more detailed descriptions, reference may be made to the related content of FIG. 4.

Step 230, predicting the upstream congestion condition of the target tunnel according to the abnormal event, the congestion data, and the peripheral traffic flow data of the target tunnel.

The peripheral traffic flow data refers to traffic operation data of connecting road sections related to the target tunnel. For example, the traffic operation data of the upstream road sections of the target tunnel.

In some embodiments, the peripheral traffic flow data may include the road section average vehicle speed, road section traffic density, the intersection queue length, and the area traffic flow.

The road section average vehicle speed refers to an average value of instantaneous speeds of all vehicles on the connecting road sections.

The road section traffic density refers to a ratio of a number of vehicles to a road section area on the connecting road sections.

The intersection queue length refers to a vehicle queue length of an intersection located on the upstream road sections of the target tunnel.

The area traffic flow refers to a number of vehicles passing through the connecting road sections within a unit time. The acquisition manner of the area traffic flow is the same as that of the lane traffic flow in the congestion data, the acquisition manner of the intersection queue length is the same as that of the vehicle queue length in the congestion data, the acquisition manner of the road section average vehicle speed is the same as that of the average vehicle speed in the congestion data, and the acquisition manner of the road section traffic density is the same as that of the traffic density in the congestion data. For a detailed description, refer to relevant content of step 220.

The upstream congestion condition refers to a predicted traffic congestion condition of the upstream road sections of the target tunnel during a future time period. The future time period may be determined by manual presetting.

In some embodiments, the upstream congestion condition includes the predicted average vehicle speed and the predicted queue length.

The predicted average vehicle speed refers to a predicted average value of instantaneous speeds of all vehicles during the future time period.

The predicted queue length refers to a predicted vehicle queue length during the future time period.

In some embodiments, the emergency supervision management platform may predict the upstream congestion condition of the target tunnel in a plurality of manners according to the abnormal event, the congestion data, and the peripheral traffic flow data of the target tunnel.

In some embodiments, the emergency supervision management platform may construct a second target vector based on the abnormal event, the congestion data, and the peripheral traffic flow data; construct a second vector database based on a large amount of historical data from a data center, the second vector database including a plurality of second reference vectors and reference congestion conditions corresponding to the second reference vectors; determine the second reference vector with the highest similarity to the second target vector through vector matching, and determine the reference congestion condition corresponding to the second reference vector as the upstream congestion condition of the second target vector.

In some embodiments, the second reference vector may be constructed by obtaining the abnormal event, the congestion data, and the peripheral traffic flow data corresponding to an actually occurring abnormal event in historical data; an actual congestion condition of a plurality of upstream road sections of the target tunnel when the abnormal event occurs may be obtained through a camera, and the reference congestion condition corresponding to the second reference vector may be determined.

In some embodiments, the emergency supervision management platform may also predict the upstream congestion condition based on a congestion prediction model. For more detailed description, refer to relevant content of FIG. 5.

Step 240, generating the signal regulation instruction including the passage duration according to the upstream congestion condition.

The signal regulation instruction refers to an instruction set for controlling an operation state and parameters of a signal light. The signal regulation instruction is configured to control the target signal light to maintain the target state for the passage duration, and the target signal light is the signal light on the key road section in the direction toward the target tunnel.

The signal light refers to a traffic indicator light on a lane, such as a traffic light.

The target state refers to a state where the signal light is a green light.

The key road section refers to an upstream road section where the degree of change of the congestion data satisfies the preset change condition when an abnormal event occurs in the target tunnel. For example, a main road directly connecting to the entrance of the target tunnel, or a road intersection within 3 kilometers from the entrance of the target tunnel.

The degree of change of the congestion data refers to a change condition of the congestion data when an abnormal event occurs in the target tunnel. For example, a degree of decrease of the average vehicle speed.

The preset change condition refers to a standard for determining whether a road section affects an abnormal event occurring in the target tunnel. The preset change condition may be determined by manual presetting. For example, the preset change condition may be that the average vehicle speed decreases to 50% of a minimum speed limit standard stipulated by a government traffic department or the average vehicle speed decreases to 50% of a historical average vehicle speed.

In some embodiments, the signal regulation instruction is configured to control at least one signal light on the key road section in the direction toward the target tunnel to perform green light display for the passage duration.

In some embodiments, the signal regulation instruction may include the passage duration.

The passage duration refers to a maintenance duration of the target state of the signal light, such as a display duration of a green light.

In some embodiments, the emergency supervision management platform may determine the passage duration in a plurality of manners according to the upstream congestion condition.

In some embodiments, the emergency supervision management platform may determine the passage duration by querying the first preset table according to the upstream congestion condition.

The first preset table refers to a mapping relationship table of the upstream congestion condition and the passage duration.

The first preset table may be constructed based on historical data or historical experience.

In some embodiments, the actual upstream congestion condition when an abnormal event historically occurs in the target tunnel may be obtained; an adjusted passage duration satisfying the preset requirements may be obtained after reducing a green light duration of a plurality of upstream key road sections leading to the target tunnel; the adjusted passage duration may be mapped to the actual upstream congestion condition, and the first preset table may be constructed. The adjusted passage duration refers to the passage duration of vehicles that can alleviate the congestion of the target tunnel after adjusting the green light duration.

The preset requirements refer to a standard for determining whether the passage duration can alleviate the congestion. The actual upstream congestion condition is the upstream congestion condition corresponding to a time point when the abnormal event historically occurs.

In some embodiments, the preset requirements may include that the average vehicle speed of the key road sections is greater than a vehicle speed threshold, and the vehicle queue length of the key road sections is less than a queue length threshold. The vehicle speed threshold and the queue length threshold are set based on manual experience.

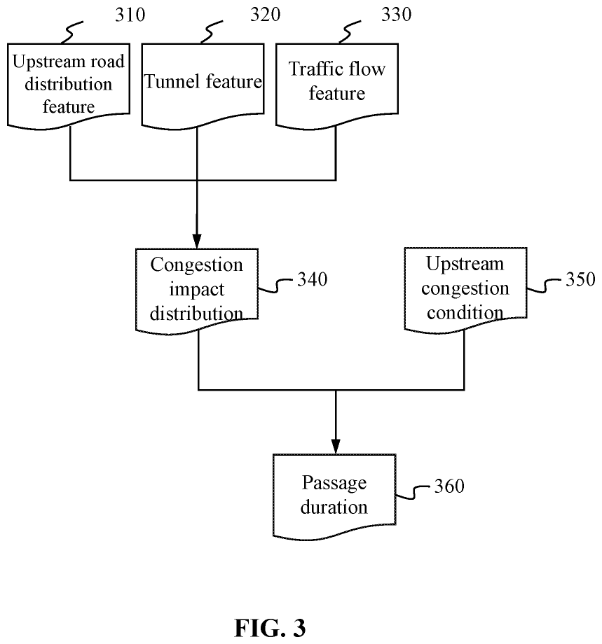

In some embodiments, the emergency supervision management platform may also determine the passage duration according to the upstream congestion condition and the congestion impact distribution of the target tunnel. For more description, refer to relevant content of FIG. 3.

Step 250, controlling the target signal light to maintain the target state for the passage duration according to the signal regulation instruction.

In some embodiments, the emergency supervision management platform may control the target signal light to maintain the target state for the passage duration according to the signal regulation instruction.

For example, when the signal regulation instruction is [key road section A, passage duration 60 seconds], the emergency supervision management platform controls the green light of the key road section A to maintain for 60 seconds.

Some embodiments of the present disclosure are capable of accurately identifying minor abnormal events in the target tunnel, and predicting in advance a tendency and a scope of congestion spreading to the upstream road sections. The embodiments are also capable of regulating traffic signal lights on key roads, actively restricting merging traffic flow before severe congestion forms, thereby achieving a transition from ‘passive response to congestion’ to ‘active prevention of congestion’, and shortening a response time from event occurrence to diversion implementation. Furthermore, the embodiments are capable of avoiding delays and misjudgments of manual intervention, thereby reducing a risk of regional traffic paralysis caused by a sudden event occurring in the target tunnel.

In some embodiments, the method for emergency supervision of tunnel traffic in smart cities method may further comprise: determining a detour route according to the upstream congestion condition and the peripheral traffic flow data; generating a detour prompt instruction according to the detour route; and controlling a remote information board on the key road section to display a detour prompt, and controlling an in-vehicle terminal within the key road section to display the detour prompt according to the detour prompt instruction.

The detour route refers to an alternative passage path planned for vehicles to avoid congestion, accidents, and the like. For example, when a main road experiences congestion, a secondary road may be used as a detour route.

In some embodiments, the emergency supervision management platform may determine a detour route according to the upstream congestion condition and the peripheral traffic flow data. For example, the emergency supervision management platform may determine the target tunnel, whose upstream congestion condition satisfies a preset congestion condition, to be an impending congestion point, and determine at least one connecting road section, whose peripheral traffic flow data satisfies a preset smooth-flow condition, and which is located upstream of the target tunnel, as a detour route. Through a dedicated Application Programming Interface (API) interface, the emergency supervision management platform uploads the detour route to a third-party map navigation service provider. The server of the third-party map navigation service provider determines a detour time and returns the detour time and the detour route to the emergency supervision management platform through the API interface.

The preset congestion condition and the preset smooth-flow condition may be determined based on historical experience. For example, the preset congestion condition is the predicted average vehicle speed of less than 15 km/h. For example, the preset smooth-flow condition is the road section average vehicle speed of greater than 40 km/h.

The detour prompt instruction refers to a set of instructions conveyed to drivers, monitoring personnel, and the like. For example, ‘Congestion ahead, please exit main road 1 at intersection 3’.

In some embodiments, the emergency supervision management platform may generate a detour prompt instruction according to the detour route. For example, according to the detour time and the detour route returned by the API interface, a detour prompt instruction ‘Congestion ahead, please continue straight for 50 meters along the current road and then turn right’ is sent to a driver.

The remote information board refers to a display device set up on a road for displaying traffic information. For example, a large display screen installed at a main road intersection.

The in-vehicle terminal refers to a terminal device installed inside a vehicle and configured to receive instructions from the emergency supervision management platform. For example, a driving recorder, an in-vehicle navigation system, and the like.

In some embodiments, the emergency supervision management platform may control a remote information board on the key road section to display detour prompt, and control an in-vehicle terminal within the key road section to display the detour prompt according to the detour prompt instruction.

For example, the emergency supervision management platform simultaneously sends the detour prompt instruction ‘Congestion ahead, please continue straight for 50 meters along the current road and then turn right’ to a large display screen on a lane and an in-vehicle navigation system of a vehicle for display.

Some embodiments of the present disclosure further combine real-time road conditions based on predicting congestion and regulating the signal lights to actively generate a detour route, and publish guidance information through multiple channels such as the remote information boards and the in-vehicle terminals, which achieves the transformation from passive control of “curbing congestion at the source” to active guidance of “bypassing congestion points”, providing drivers with clear and feasible alternative solutions, and significantly improving the overall traffic efficiency and emergency response capability of the regional road network.

FIG. 3 is a schematic diagram illustrating an exemplary process for determining passage duration according to some embodiments of the present disclosure.

In some embodiments, the emergency supervision management platform may further determine the passage duration 360 according to the upstream congestion condition 350 and the congestion impact distribution 340 of the target tunnel.

The congestion impact distribution 340 refers to a degree of negative impact generated by congestion of the target tunnel on upstream key road sections.

In some embodiments, the congestion impact distribution includes a key road section and a degree of impact of congestion of the target tunnel on the key road section. For example, it is represented as: key road section A (a main road, directly connected to the target tunnel), with an influence degree W_{A}=0.9; key road section B (a secondary road, indirectly merging), with an influence degree W_{B}=0.6.

In some embodiments, the emergency supervision management platform may determine the congestion impact distribution of the target tunnel through a plurality of manners. For example, the emergency supervision management platform may determine an actual vehicle speed variation amplitude for each key road section when the abnormal event occurs in the target tunnel based on historical data and map a vehicle speed decrease amplitude to an influence degree of a corresponding key road section to obtain the congestion impact distribution. The more significant the vehicle speed decrease of a key road section, the higher the influence degree, and vice versa.

In some embodiments, the emergency supervision management platform may further determine the congestion impact distribution 340 of the target tunnel according to the upstream road distribution feature 310, the tunnel feature 320, and the traffic flow feature 330 of the target tunnel.

Detailed descriptions regarding the upstream road distribution feature, the tunnel feature, the traffic flow feature, and determining the congestion impact distribution refer to relevant content in FIG. 5.

Some embodiments of the present disclosure can dynamically determine a potential impact range and distribution of a congestion event by combining physical features of the target tunnel with real-time traffic flow features.

In some embodiments, the emergency supervision management platform may determine the passage duration according to the upstream congestion condition and the congestion impact distribution of the target tunnel.

In some embodiments, the passage duration may be determined based on the upstream congestion condition of the key road section and the congestion impact distribution of the target tunnel.

For example, the passage duration may be determined sequentially through Formulas (1), (2), and (3):

$$C = 0.5 \times {S}_{v} + 0.5 \times {S}_{q} . \qquad ( 1 )$$

In Formula (1), C is a congestion score, representing an overall congestion degree of a key road section; Sᵥ is a vehicle speed score, representing a speed decrease degree of traffic flow of the key road section; and S_{q} is a queue score, representing a severity degree of vehicle queuing condition of the key road section at a future time.

Sᵥ is obtained by determining a ratio of the congestion critical vehicle speed of a key road section to the predicted average vehicle speed. When the predicted average vehicle speed is 0, or the aforementioned ratio is greater than 1, Sᵥ is corrected to 1 by default. The congestion critical vehicle speed refers to a critical value of vehicle speed when congestion is about to occur. The congestion critical vehicle speed may be set based on manual experience.

S_{q} is obtained by determining a ratio of a queue length of a key road section at a future time to the maximum warning length. The maximum warning length refers to a road section length.

$$P = C \times W . \qquad ( 2 )$$

In Formula (2), P is a regulation pressure index, representing a pressure of a key road section on passage duration regulation; and W is an influence degree of a key road section, representing a degree to which the key road section is affected by the abnormal event of the target tunnel.

$$T = {t}_{1} - ( {t}_{1} - {t}_{2} ) \times P . \qquad ( 3 )$$

In Formula (3), T is the passage duration; t₁ represents a green light duration under normal conditions; and t₂ represents a shortest green light duration for ensuring safe passage. t₁ and t₂ are set based on manual experience. For example, t₁ is 60 seconds, and t₂ is 15 seconds.

Regarding a determination manner of the predicted average vehicle speed and the predicted queue length, refer to relevant description in FIG. 1. Regarding a determination manner of the influence degree, refer to relevant description in FIG. 5.

By determining the passage duration of the signal lights based on the congestion impact distribution, some embodiments of the present disclosure can achieve a transition from ‘extensive’ regional traffic restriction to ‘precise’ differentiated regulation. This enables the precise identification of the upstream key road sections that contribute most to the tunnel congestion and allows for focused and strong traffic flow reduction on them. At the same time, only slight restrictions are applied to secondary road sections with less influence. This not only greatly improves the efficiency and targeting of source traffic restriction, but also avoids unnecessary interference to peripheral traffic caused by ‘one-size-fits-all’ regulation, thereby achieving a balance between ensuring emergency diversion effects and maintaining regional traffic order.

FIG. 4 is a schematic diagram illustrating an exemplary abnormality identification model according to some embodiments of the present disclosure.

In some embodiments, the emergency supervision management platform may further determine an abnormal event 440 through an abnormality identification model 430 according to a fusion feature vector 410 and congestion data 420.

The abnormality identification model 430 refers to a model for determining the abnormal event.

The abnormality identification model is a machine learning model. For example, the abnormality identification model may be any one or a combination of a Long Short-Term Memory (LSTM) model or other custom model structures.

An input of the abnormality identification model includes the fusion feature vector and the congestion data of a single vehicle, and an output of the abnormality identification model includes an abnormal type and an abnormal degree corresponding to the vehicle.

For detailed descriptions of the fusion feature vector, the congestion data, the abnormal type, and the abnormal degree, refer to related content in FIG. 1.

In some embodiments, the abnormality identification model may be obtained by training with a plurality of first training samples with first labels. For example, the plurality of first training samples with the first labels may be input into an initial identification model, a loss function may be constructed based on the first labels and the results of the initial identification model, and parameters of the initial identification model may be iteratively updated through gradient descent or other manners based on the loss function. When a preset condition is satisfied, training of the model is completed, and the trained abnormality identification model is obtained. The preset condition may be convergence of the loss function, a number of iterations reaching a threshold, and so on.

The first training sample may include a historical fusion feature vector and historical congestion data.

For the first training sample, the first label may include an actual abnormal type and an actual abnormal degree corresponding to the abnormal event when the abnormal event actually occurs.

In some embodiments, the first training sample and the first label may be obtained based on the historical data.

For example, the fusion feature vector and the congestion data of the single vehicle are obtained when the abnormal event actually occurs in the historical data, the actual abnormal type and the actual abnormal degree of the abnormal event are manually labeled, and the first label is obtained.

In some embodiments of the present disclosure, the abnormality identification model can automatically learn and understand behavior patterns of vehicles over continuous time, and more sensitively capture subtle and critical changes in vehicle movement data, thereby accurately identifying complex abnormal events that are difficult to determine based on instantaneous states alone, further improving the accuracy and comprehensiveness of abnormal event identification, and making the emergency response more timely and effective.

In some embodiments, the emergency supervision management platform may further generate a lane regulation instruction according to a lane corresponding to the abnormal event; and control a lane indicator located upstream of the lane to display a prohibition signal, and activate a signal light at a ramp entrance of the lane to display in a preset display state according to the lane regulation instruction.

For a manner of determining the lane corresponding to the abnormal event, refer to related content of step 220 in FIG. 1.

The lane regulation instruction refers to a set of instructions for controlling lane passage. For example, prohibition of passage for lane X, permission of passage for lane Y, and so on.

In some embodiments, the lane regulation instruction may include an instruction for controlling the lane indicator and an instruction for controlling the signal light at the ramp entrance.

The lane indicator refers to a visual device for indicating whether a lane is open for passage. For example, a display screen.

The prohibition signal refers to a specific signal displayed by the lane indicator, indicating to vehicles that the passage through the lane is prohibited. For example, a red symbol ‘x’ or any other graphical symbol.

The preset display state refers to a display state of the lane indicator that is manually preset.

In some embodiments, the preset display state may include permission of passage and prohibition of passage.

In some embodiments, the emergency supervision management platform may generate the lane regulation instruction according to the lane corresponding to the abnormal event; and control the lane indicator located upstream of the lane to display the prohibition signal, and activate the signal light at the ramp entrance of the lane to display in the preset display state according to the lane regulation instruction.

For example, if the abnormal event exists in a lane I, the emergency supervision management platform generates the lane regulation instruction for prohibition of passage for the lane I, and the lane indicator upstream of the lane I displays the red symbol ‘x’; if the target tunnel has a ramp, the emergency supervision management platform generates the lane regulation instruction ‘release one vehicle every 15 seconds’, and the signal light at the ramp entrance operates alternately, with a green light duration of 3 seconds and a red light duration of 15 seconds.

In some embodiments of the present disclosure, a granularity of the emergency response is refined from a macroscopic road section level to a lane level. When a blockage occurs in a specific lane, the system can immediately and accurately close an upstream entrance of the lane and guide traffic flow, effectively preventing the occurrence of secondary accidents. In addition, when dealing with mainline congestion, the system proactively controls merging traffic flow by activating the ramp signal light, which realizes dynamic regulation of a ‘micro-circulation’ of tunnel traffic and can effectively delay or mitigate accumulation of mainline congestion.

FIG. 5 is a schematic diagram illustrating an exemplary process for predicting the upstream congestion condition according to some embodiments of the present disclosure.

In some embodiments, the emergency supervision management platform is further configured to: construct a congestion map 540 according to the congestion data 510, an abnormal event 520, and target traffic flow data 530; and predict the upstream congestion condition 560 through a congestion prediction model 550 according to the congestion map 540. For descriptions of the congestion data, the abnormal event, and the upstream congestion condition, reference is made to FIG. 2 and its content.

The target traffic flow data refers to peripheral traffic flow data within a preset range of the target tunnel.

The preset range refers to a preset farthest peripheral range from the target tunnel. In some embodiments, the preset range may be determined based on a manual preset. In some embodiments, the preset range may also be determined based on an upstream road distribution feature of the target tunnel, a tunnel feature, and a traffic flow feature.

In some embodiments, the emergency supervision management platform is further configured to: determine a congestion impact distribution of the target tunnel according to an upstream road distribution feature of the target tunnel, a tunnel feature, and a traffic flow feature; and determine the preset range according to the congestion impact distribution.

The upstream road distribution feature refers to a distribution feature of an upstream road of the target tunnel. The upstream road refers to a road whose travel direction is to merge into the target tunnel.

In some embodiments, the upstream road distribution feature includes a number of roads merging into the target tunnel and a number of lanes. The number of lanes of different upstream roads may be different. For example, the upstream roads may include a road merging into the target tunnel after going straight and a road merging into the target tunnel after turning right, the number of lanes of the road merging into the target tunnel after going straight is 2, and the number of lanes of the road merging into the target tunnel after turning right is 1. The emergency supervision management platform may determine the upstream road distribution feature based on a pre-obtained survey report.

The tunnel feature refers to related features of the target tunnel. For example, a tunnel width, the number of lanes within the tunnel, and a tunnel length, and the like. In some embodiments, the emergency supervision management platform may determine the tunnel feature based on a pre-obtained survey report.

The traffic flow feature refers to features related to traffic flow within the target tunnel. For example, traffic flow density, traffic flow type, and the like.

The traffic flow density refers to the vehicle density within the target tunnel. In some embodiments, the traffic flow density may be obtained based on the congestion data.

The traffic flow type refers to types of vehicles within the target tunnel and a number of different vehicle types. For example, sedan (15 vehicles), truck (13 vehicles), and the like. In some embodiments, the emergency supervision management platform may obtain vehicle types based on the multi-dimensional data of the target tunnel and count the number of vehicles corresponding to each vehicle type.

For a description of the congestion impact distribution, reference is made to FIG. 3 and its content.

In some embodiments, the emergency supervision management platform may determine a congestion impact distribution of the target tunnel according to an upstream road distribution feature of the target tunnel, a tunnel feature, and a traffic flow feature. For example, the emergency supervision management platform may construct a vector to be matched based on an upstream road distribution feature of the target tunnel, a tunnel feature, and a traffic flow feature, query a third vector database for a third reference vector satisfying a matching condition with the vector to be matched, and determine a label of the third reference vector as the congestion impact distribution of the target tunnel. The matching condition includes the highest similarity between the vectors. Vector similarity is negatively correlated with vector distance. Vector distance includes Euclidean distance and the like.

In some embodiments, the third vector database may be preset based on historical data, and includes a plurality of third reference vectors and a label corresponding to each third reference vector. For example, the emergency supervision management platform may obtain historical data when historical abnormal events occur, construct corresponding third reference vectors based on historical upstream road distribution features, historical tunnel features, and historical traffic flow features of historical target tunnels when respective historical abnormal events occur in the historical data, and determine a historical congestion impact distribution corresponding to each set of a historical upstream road distribution feature, a historical tunnel feature, and a historical traffic flow feature as a label of the corresponding third reference vector. For example, a label of the third reference vector may be {(the key road section A, A1), (the key road section B, B1)}, where A1 and B1 are respectively impact degrees corresponding to the key road section A and the key road section B, which correspond to the historical target tunnel.

In some embodiments, the label of the third reference vector may be determined by manual labeling, including: obtaining congestion data of upstream roads of a historical target tunnel corresponding to the third reference vector, acquiring the degree of change when the change trend within a preset historical period is a decrease in average speed, determining a road section whose the degree of change satisfies the preset change condition, as the key road section, and determining the corresponding degree of change of the key road section as the impact degree.

For example, if a degree of decrease in the average speed corresponding to a certain road section is 60%, that is, the degree of change of the congestion data is 60%, which exceeds the preset change condition (e.g., an average speed decrease of 50%), the road section is determined as the key road section, and a corresponding impact degree is 0.6. For another example, if the average speed corresponding to a certain road section is in an increasing state, it means that the road section has smooth traffic flow, that is, the road section is not the key road section. For descriptions of the degree of change of the congestion data, the key road section, and the preset change condition, reference is made to FIG. 2 and its content.

In some embodiments, the emergency supervision management platform may determine, from the congestion impact distribution, a distance between the key road section farthest from the target tunnel and the target tunnel as the preset range of the target tunnel.

In some embodiments of the present disclosure, by combining the tunnel feature with a real-time traffic flow feature, a potential impact range and distribution of a congestion event are dynamically determined, thereby providing a reasonably preset range for emergency supervision, which can precisely focus on key road sections truly affected by an abnormal event, improve the pertinence and effectiveness of emergency response, and avoid resource waste caused by an excessively large supervision range or management omissions caused by an excessively small supervision range.

The congestion map 540 refers to a map representing traffic congestion conditions, and may be used to determine the upstream congestion condition. In some embodiments, the congestion map is composed of nodes and edges. As shown in FIG. 5, the congestion map 540 includes the plurality of nodes (for example, A, B, A1, B1, A2) and the plurality of directed edges, and the directed edges include unidirectional edges and bidirectional edges.

In some embodiments, the nodes of the congestion map may include central nodes and diffusion nodes.

In some embodiments, the emergency supervision management platform may determine the central nodes, the diffusion nodes, and the edges connecting the nodes according to the congestion data 510, the abnormal event 520, and the target traffic flow data 530, so as to construct the congestion map.

The central node refers to a node that may represent the target tunnel. In some embodiments, the target tunnel may be divided into a plurality of tunnel key road sections, and each of the tunnel key road sections corresponds to the central node.

The tunnel key road section refers to a key road section in the target tunnel. For example, the target tunnel may be divided into a plurality of tunnel key road sections such as an ‘entrance section’, a ‘middle section’, an ‘exit section’, and a ‘ramp merging section’, and each of the tunnel key road sections may correspond to the central node, for example, A, A1, A2 in FIG. 5.

In some embodiments, node attribute of the central node may include data related to the tunnel key road section. For example, the corresponding tunnel feature, the congestion data, and the event severity index of the tunnel key road section. For a description of the congestion data, reference is made to FIG. 2 and the content thereof. For a description of the tunnel feature, reference is made to the content above FIG. 5.

The event severity index refers to a value used to characterize a severity of the abnormal event. In some embodiments, the event severity index may be a normalized value between 0 and 1. The emergency supervision management platform may determine the event severity index based on the real-time state of the abnormal event according to a preset rule. For example, the preset rule may include as follows: when there is no abnormal event, the event severity index is 0; when there is an abnormal event in a single lane, the event severity index is 0.5; when there is an abnormal event in a plurality of lanes, the event severity index is 0.8; and when there is the complete blockage of the tunnel, the event severity index is 1.0. The complete blockage of the tunnel may refer to a condition where the average speed of the key road section is less than an average speed threshold, and the average speed threshold may be determined based on an empirical preset. The presence of the abnormal event in the plurality of lanes refers to a condition where the abnormal event simultaneously exists in two or more lanes.

The diffusion node refers to a node that may represent a key road section of the upstream road of the target tunnel. In some embodiments, the upstream road of the target tunnel may also be divided into a plurality of key road sections, and one key road section of the upstream road corresponds to the diffusion node, for example, B, B1, B2 in FIG. 5. Node attribute of the diffusion node may include data related to the upstream road section. For example, the peripheral traffic flow data corresponding to the key road section of the upstream road. For a description of the peripheral traffic flow data, reference is made to FIG. 2 and the content thereof.

In some embodiments, a plurality of nodes may be connected by edges. The edges may include connection edges and logical edges.

The connection edge refers to a directed edge representing the traffic flow direction between key road sections. For example, the solid line edges shown in FIG. 5. In some embodiments, when a connection relationship (for example, mutual connection) exists between two key road sections corresponding to two nodes, the two nodes are connected based on the connection edge. The direction of the edge is the traffic flow direction. The traffic flow direction refers to a driving direction of road planning. For example, as shown in FIG. 5, A is an exit section, A1 is a middle section, A2 is an entrance section, and the traffic flow direction is A2-A1-A.

In some embodiments, connection edges can exist between the diffusion nodes, between the diffusion node and the central node, and between the central nodes. For example, as shown in FIG. 5, a connection edge exists between the diffusion node B and the diffusion node B2, a connection edge exists between the central node A and the diffusion node B, and a connection edge exists between the central node A and the central node A1. The central node representing the entrance or the exit of the target tunnel may be connected to the diffusion node.

In some embodiments, features of the connection edges include throughput capacity and a lane count change.

The throughput capacity refers to a maximum traffic volume that can pass through the connection points of the nodes per hour. In some embodiments, the connection points of the nodes may include intersections, ramps, and the like. The throughput capacity may be obtained based on historical records.

The lane count change refers to a difference in lane count between two nodes. For example, as shown in FIG. 5, the lane count of the node A2 is 3, the lane count of the node A1 is 2, the traffic flow direction is A2-A1, and the lane count change is ⅔. Because the lane count narrows, the vehicle density may increase, and the probability of abnormal events occurring may also increase. In some embodiments, the lane count change may be determined based on the tunnel feature. For a description of the tunnel feature, reference is made to the related content of FIG. 5.

The logical edge refers to a directed edge representing a relationship of the congestion condition among the plurality of nodes. For example, the dashed line edges shown in FIG. 5. In some embodiments, when a causal relationship of congestion exists between two key road sections corresponding to two nodes, the two nodes are connected based on the logical edge. The causal relationship of congestion refers to a relationship in which an abnormal event occurring at a downstream node causes a change in the traffic condition at an upstream node. The direction of the logical edges is an opposite direction to the traffic flow direction, that is, pointing from the downstream node to the upstream node. For example, as shown in FIG. 5, the traffic flow direction is A2-A1-A, then the direction of the logical edges is A-A1-A2.

In some embodiments, the logical edge may exist between the diffusion node and the central node, and the logical edge may exist between the central nodes. For example, as shown in FIG. 5, the logical edge exists between the central node A and the diffusion node B, and the logical edge exists between the central node A and the central node A1. Logical edges do not exist between the diffusion nodes. Only central nodes representing the entrance or the exit of the target tunnel may have logical edges with the diffusion nodes.

In some embodiments, features of the logical edges include an influence weight. The influence weight refers to an influence degree of the downstream node on the traffic condition of the upstream node. The influence weight may be determined based on the influence degree. For a description of influence degree, reference is made to the related contents of FIG. 3 and FIG. 5.

In some embodiments, if the connection edge and the logical edge simultaneously exist between two nodes, a bidirectional edge is formed, which represents that a connection relationship and a causal relationship of congestion simultaneously exist between the key road sections corresponding to the two nodes.

In some embodiments, the emergency supervision management platform is further configured to: determine the central node and the diffusion node according to the tunnel feature of the target tunnel, the congestion data, and the target traffic flow data; and construct the congestion map according to the central node and the diffusion node.

In some embodiments, the emergency supervision management platform may determine the central node based on the tunnel feature and the congestion data. For example, the emergency supervision management platform may determine a node attribute of a tunnel key road section (i.e., the central node) based on the corresponding tunnel feature and the congestion data of the tunnel key road section.

In some embodiments, the emergency supervision management platform may determine the diffusion node based on the target traffic flow data. For example, the emergency supervision management platform may determine the peripheral traffic flow data corresponding to a plurality of key road sections of upstream roads based on the target traffic flow data. Each of the peripheral traffic flow data corresponds to a node attribute of a key road section of an upstream road (i.e., the diffusion node).

In some embodiments, the emergency supervision management platform constructs the congestion map according to the central nodes, the diffusion nodes, and the first-type edges and the second-type edges connecting the various nodes.

The first-type edge refers to a logical edge between the central nodes. For example, as shown in FIG. 5, the logical edge A1A2 between the central node A2 and the central node A1.

The second-type edge refers to a logical edge between the central node and the diffusion node. For example, as shown in FIG. 5, the logical edge A2B between the central node A2 and the diffusion node B.

In some embodiments, in the congestion map, the edge feature of the first-type edge and the second-type edge includes the influence weight, and the influence weight corresponding to the first-type edge is not less than the influence weight corresponding to the second-type edge.

As described in content related to FIG. 3, the influence degree of a downstream node on a traffic condition of an upstream node refers to the severity of the influence of an abnormal event of the downstream node on the upstream node. In some embodiments, the emergency supervision management platform may determine the influence degree of the diffusion node (i.e., the node in the upstream direction) connected by the second-type edge as the influence weight of the second-type edge. For the determination and description of the influence degree, refer to the corresponding content of FIG. 3.

As shown in FIG. 5, the central node (for example, A1) located at a middle position in the target tunnel cannot be connected to the diffusion node. That is, only one central node of two central nodes connected by the first-type edge is connected to the diffusion node. Therefore, for a first-type edge (for example, A1A2), the emergency supervision management platform may also determine the central node (for example, A2) connected to the diffusion node in the first-type edge, obtain all the second-type edges (for example, A2B) connected to the central node, add the maximum influence weight among one or a plurality of the second-type edges to a conventional item C, and use the sum as the influence weight of the first-type edge (for example, A1A2). The conventional item C may be determined by manual experience.

In some embodiments, the maximum influence weight is 1. When the calculated value of the influence weight is greater than 1, the emergency supervision management platform determines the influence weight to be 1.

In some embodiments of the present disclosure, by assigning the influence weight to an edge between nodes of the congestion map, the influence degree of traffic of a downstream road section on an upstream road section can be intuitively displayed, which is convenient for subsequently determining the upstream congestion condition according to the congestion prediction model.

In some embodiments, the emergency supervision management platform may predict the upstream congestion condition 560 through the congestion prediction model 550 according to the congestion map 540.

The congestion prediction model refers to a model used for predicting the upstream congestion condition. In some embodiments, the congestion prediction model may be a machine learning model. For example, the congestion prediction model may be a Graphic Neural Network (GNN), or the like. In some embodiments, an input of the congestion prediction model may include the congestion map, and an output of the congestion prediction model may include the upstream congestion condition of the target tunnel.

In some embodiments, the emergency supervision management platform may construct the congestion prediction model by training a large amount of training samples and training labels corresponding to the training samples. In some embodiments, the emergency supervision management platform may obtain a training data set, the training data set includes a plurality of second training samples and a second training label corresponding to each of the second training samples, and the emergency supervision management platform may perform a plurality of iterations to obtain the trained congestion prediction model. The training of the congestion prediction model is the same as the training of the abnormality identification model. For a specific description, refer to the training description of the abnormality identification model.

In some embodiments, the emergency supervision management platform may determine historical abnormal events at the first time point and corresponding congestion data and target traffic flow data within the preset range from historical data, construct a historical congestion map, and use the historical congestion map as a second training sample. The emergency supervision management platform may obtain the actual congestion condition of all key road sections of an upstream road of the target tunnel corresponding to each of the second training samples at the second time point, and use the actual congestion condition as the second training label based on manual annotation. The first time point and the second time point are both historical time points, the first time point is before the second time point, and a time interval between them may be preset based on manual experience, for example, 5 minutes.

In some embodiments of the present disclosure, by using the trained machine learning model, a traffic road network can be processed as an integrated and interrelated system, instead of merely analyzing isolated road section data. By learning the propagation rules of the upstream congestion condition in a road network topology, the congestion prediction model can accurately predict a manner and a speed of the influence of the abnormal event of the target tunnel on various upstream road sections connected to the target tunnel, so that a prediction result is closer to a congestion spreading process of a real situation, thereby formulating more forward-looking and comprehensive guidance strategies for the abnormal event.

Basic concepts have been described in the foregoing. It is apparent to a person skilled in the art that detailed disclosure is merely illustrative and does not constitute a limitation on the present disclosure. Although not explicitly described herein, a person skilled in the art may make various modifications, improvements, and revisions to the present disclosure. Such modifications, improvements, and revisions are contemplated in the present disclosure, and therefore, the modifications, improvements, and revisions still fall within the spirit and scope of the exemplary embodiments of the present disclosure.

Finally, it should be understood that the embodiments described in the present disclosure are merely for illustrating principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly presented and described in the present disclosure.

What is claimed is:

1. A system for emergency supervision of tunnel traffic in smart cities based on an Internet of Things (IoT) large model, comprising: an emergency supervision management platform, wherein the emergency supervision management platform is configured to:
construct a fusion feature vector of a vehicle in a target tunnel according to multi-dimensional data of the target tunnel;
determine an abnormal event according to the fusion feature vector and congestion data of the target tunnel;
predict an upstream congestion condition of the target tunnel according to the abnormal event, the congestion data, and peripheral traffic flow data of the target tunnel; and
generate a signal regulation instruction including a passage duration according to the upstream congestion condition, wherein the signal regulation instruction is configured to control a target signal light to maintain a target state for the passage duration, and the target signal light is a signal light on a key road section in a direction toward the target tunnel.

2. The system according to claim 1, wherein the emergency supervision management platform is further configured to:
determine a detour route according to the upstream congestion condition and the peripheral traffic flow data; and
generate a detour prompt instruction according to the detour route, wherein the detour prompt instruction is configured to control a remote information board on the key road section to display a detour prompt, and control an in-vehicle terminal within the key road section to display the detour prompt.

3. The system according to claim 1, wherein the emergency supervision management platform is further configured to:
determine the passage duration according to the upstream congestion condition and a congestion impact distribution of the target tunnel.

4. The system according to claim 3, wherein the emergency supervision management platform is further configured to:
determine the congestion impact distribution of the target tunnel according to an upstream road distribution feature, a tunnel feature, and a traffic flow feature of the target tunnel.

5. The system according to claim 1, wherein the emergency supervision management platform is further configured to:
determine the abnormal event through an abnormality identification model according to the fusion feature vector and the congestion data, wherein the abnormality identification model is a machine learning model.

6. The system according to claim 5, wherein the emergency supervision management platform is further configured to:
generate a lane regulation instruction according to a lane corresponding to the abnormal event, wherein the lane regulation instruction is configured to control a lane indicator located upstream of the lane to display a prohibition signal, and activate a signal light at a ramp entrance of the lane to display in a preset display state.

7. The system according to claim 1, wherein the emergency supervision management platform is further configured to:
construct a congestion map according to the congestion data, the abnormal event, and target traffic flow data, wherein the target traffic flow data is peripheral traffic flow data within a preset range of the target tunnel; and
predict the upstream congestion condition through a congestion prediction model according to the congestion map, wherein the congestion prediction model is a machine learning model.

8. The system according to claim 7, wherein the emergency supervision management platform is further configured to:
determine a central node and a diffusion node according to a tunnel feature of the target tunnel, the congestion data, and the target traffic flow data; and
construct the congestion map according to the central node and the diffusion node, wherein in the congestion map, an influence weight corresponding to a first-type edge is not less than an influence weight corresponding to a second-type edge, the first-type edge is an edge between central nodes, and the second-type edge is an edge between the central node and the diffusion node.

9. The system according to claim 7, wherein the emergency supervision management platform is further configured to:
determine a congestion impact distribution of the target tunnel according to an upstream road distribution feature, a tunnel feature, and a traffic flow feature of the target tunnel; and
determine the preset range according to the congestion impact distribution.

10. A method for emergency supervision of tunnel traffic in smart cities, wherein the method is executed based on an emergency supervision management platform and the method comprises:
constructing a fusion feature vector of a vehicle in a target tunnel according to multi-dimensional data of the target tunnel;
determining an abnormal event according to the fusion feature vector and congestion data of the target tunnel;
predicting an upstream congestion condition of the target tunnel according to the abnormal event, the congestion data, and peripheral traffic flow data of the target tunnel;
generating a signal regulation instruction including a passage duration according to the upstream congestion condition; and
controlling a target signal light to maintain a target state for the passage duration according to the signal regulation instruction, wherein the target signal light is a signal light on a key road section in a direction toward the target tunnel.

11. The method according to claim 10, further comprising:
determining a detour route according to the upstream congestion condition and the peripheral traffic flow data;
generating a detour prompt instruction according to the detour route; and
controlling a remote information board on the key road section to display a detour prompt, and controlling an in-vehicle terminal within the key road section to display the detour prompt according to the detour prompt instruction.

12. The method according to claim 10, further comprising:
determining the passage duration according to the upstream congestion condition and a congestion impact distribution of the target tunnel.

13. The method according to claim 12, further comprising:
determining the congestion impact distribution of the target tunnel according to an upstream road distribution feature, a tunnel feature, and a traffic flow feature of the target tunnel.

14. The method according to claim 10, wherein the determining an abnormal event according to the fusion feature vector and congestion data of the target tunnel comprises:
determining the abnormal event through an abnormality identification model according to the fusion feature vector and the congestion data, wherein the abnormality identification model is a machine learning model.

15. The method according to claim 14, further comprising:
generating a lane regulation instruction according to a lane corresponding to the abnormal event; and
controlling a lane indicator located upstream of the lane to display a prohibition signal, and activating a signal light at a ramp entrance of the lane to display in a preset display state according to the lane regulation instruction.

16. The method according to claim 10, wherein the predicting an upstream congestion condition of the target tunnel according to the abnormal event, the congestion data, and peripheral traffic flow data of the target tunnel comprises:
constructing a congestion map according to the congestion data, the abnormal event, and target traffic flow data, wherein the target traffic flow data is peripheral traffic flow data within a preset range of the target tunnel; and
predicting the upstream congestion condition through a congestion prediction model according to the congestion map, wherein the congestion prediction model is a machine learning model.

17. The method according to claim 16, wherein the constructing a congestion map according to the congestion data, the abnormal event, and target traffic flow data further comprises:
determining a central node and a diffusion node according to a tunnel feature of the target tunnel, the congestion data, and the target traffic flow data; and
constructing the congestion map according to the central node and the diffusion node, wherein in the congestion map, an influence weight corresponding to a first-type edge is not less than an influence weight corresponding to a second-type edge; the first-type edge is an edge between central nodes, and the second-type edge is an edge between the central node and the diffusion node.

18. The method according to claim 16, further comprising:
determining a congestion impact distribution of the target tunnel according to an upstream road distribution feature, a tunnel feature, and a traffic flow feature of the target tunnel; and
determining the preset range according to the congestion impact distribution.

19. A non-transitory computer-readable storage medium, wherein the storage medium stores computer instructions, and when a computer reads the computer instructions in the storage medium, the computer executes the method for emergency supervision of tunnel traffic in smart cities according to claim 10.
